(19) United States
(12) Patent Application Publication
(10) Pub. No.: US 2007/0038954 A1
(43) Pub. Date: Feb. 15, 2007

(54) DISPLAYING APPARATUS OF UI PARTS AND DISPLAYING METHOD OF UI PARTS

(75) Inventor: Eriko Ozaki, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/420,599

(22) Filed: May 26, 2006

(30) Foreign Application Priority Data
May 30, 2005 (JP) 2005-157968

(51) Int. Cl. G06F 15/16

(52) U.S. Cl. 715/788; 709/250; 715/517; 715/825

(57) ABSTRACT

An information processing apparatus obtains user interface data for displaying user interface parts onto a display screen of a displaying apparatus from an external apparatus, and discriminate whether the user interface part corresponding to user interface parts designation information of the user interface data obtained through an interface is displayed on the display screen by a display control process corresponding to layout designation information of the user interface data based on information regarding the display screen. If it is determined that the user interface part is not displayed on the display screen, the information processing apparatus allows the user interface part corresponding to the user interface parts designation information to be displayed by an alternative display control process of the user interface part by referring to alternative user interface parts designation information of the user interface data obtained through the interface.

### BACKGROUND OF THE INVENTION

1. Field of the Invention

The invention relates to a method of executing display control of UT parts on the basis of UT data which is transmitted from a server.

2. Related Background Art

Hitherto, in an information processing apparatus such as a personal computer (hereinafter, abbreviated to a PC) or the like, an HTML (Hyper Text Markup Language) language has widely been spread as a presentation language for various kinds of information existing in a server on the Internet. According to the HTML language, a difference between PC architectures and a difference due to browser applications can be absorbed.

In recent years, in association with the preparation of communication infrastructure, a using method whereby the information in the server is displayed on a personal digital assistant and a cellular phone by connecting to the Internet is spreading. It is, therefore, necessary to display the information in the server onto displays of terminals having different sizes, resolutions, and capabilities.

In JP-A-2001-134518, there has been disclosed a technique in which in correspondence to various information apparatuses having display screens of different sizes, the user switches a layout rule provided in the information apparatus or a processing rule according to the user input so that the information is fully displayed on the display screen of the information apparatus.

In JP-A-2001-217850, there has been disclosed a method whereby a UT (user interface) is described by logic UIs which have been layer-treed in accordance with a degree of abstraction and concrete UIs corresponding to them are defined. For example, there has been disclosed a technique in which if a function of a desired logic UI cannot be realized in a certain apparatus, a logic UI existing at a position near the layer-treed logic UIs is searched for and concrete UI parts corresponding to the searched logic UI are selected.

Although the technique of substituting the UI parts has been disclosed in JP-A-2001-217850, if the UI parts are substituted, there is a strong possibility that a layout desired by the provider of the UI cannot be provided.

With respect to display data using the HTML language which has been designed mainly on the assumption that the UI parts are displayed in the PC, when it is displayed on the displaying apparatus having the display screen of a relatively large size, the UI parts are displayed almost in accordance with the intention of the provider of the UI. On the other hand, in a cellular phone such as a PDA or the like having a relatively small display screen, there is a case where the UI parts are displayed with a part cut away or scroll-display control is endlessly made.

For example, there is presumed a layout in which control UI parts for operation as an interface regarding the selection or input by the user and UI parts constructed by a label described by text data associated with the control UI parts are continuously displayed on the display screen of the PDA. Also in such a case, if it is intended to assure a size of control UI parts by a small display screen in order to prevent the missing of the display information, the label is displayed small. If it is intended to assure a text font size of the label, the control UI parts are displayed small, so that it becomes difficult to operate.

### SUMMARY OF THE INVENTION

According to the invention, in consideration of the foregoing problems, particularly, when control UI parts and a label associated therewith are displayed, an alternative display control process in the case where a desired display screen of the provider cannot be displayed in UI data is set.

It is, therefore, an object to realize a display by optimum alternative means by using UI parts which the provider desires even when a displaying apparatus displays information onto various types of displays.

Further another object is to display information so that the display information is not missing even when a displaying method in the case where the display screen of the displaying apparatus is insufficient or the like is not finely set.

To accomplish at least one of the above objects, according to an embodiment of the invention, there is provided an information processing apparatus for controlling a display of user interface parts, comprising: an obtaining device adapted to obtain user interface data for displaying the user interface parts onto a display screen of a displaying apparatus from an outside; and a controller adapted to discriminate whether or not the user interface part corresponding to user interface parts designation information (105) of the user interface data obtained through an interface is displayed on the display screen of the displaying apparatus by a display control process corresponding to layout designation information (106) of the user interface data on the basis of information regarding the display screen of the displaying apparatus, wherein if it is determined that the user interface part is not displayed on the display screen of the displaying apparatus, the controller allows the user interface part corresponding to the user interface parts designation information (105) to be displayed by an alternative display control process of the user interface part by referring to alternative user interface parts designation information of the user interface data obtained through the interface.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a class diagram showing an example of a structure of UI data according to the first embodiment;

FIG. 2 is a class diagram showing an example of a structure of a UI rule regarding UI parts of the UI parts rule which has been layered step by step in accordance with a difference of abstraction degrees according to the first embodiment;

FIG. 3 is a diagram in the case where a part of the UI parts rule based on the UI parts installed in the first embodiment is shown by a tree structure;

FIG. 4 is a diagram in the case where a UI parts example regarding a label installed in the first embodiment is shown by a tree structure;

FIG. 5 is a diagram showing an example of UI control and a UI label according to the first embodiment;

FIG. 6 is a diagram showing an example of a UI display at the time of label priority according to the first embodiment;

FIG. 7 is a diagram showing an example of the UI display at the time of the label priority according to the first embodiment;

FIG. 8 is a diagram showing an example of the UI display at the time of control priority according to the first embodiment;

FIG. 9 is a diagram showing an example of the UI display at the time of the control priority according to the first embodiment;

FIG. 10 is a diagram showing an example of the UI display at the time of the control priority according to the first embodiment;

FIG. 11 is a diagram showing an example of the UI display at the time of the control priority according to the first embodiment;

FIG. 12 is a flowchart showing an example of the operation for setting an alternative displaying method according to the first embodiment;

FIG. 13 is a diagram showing an example of description of UI parts designation information according to the first embodiment;

FIG. 14 is a flowchart showing an example of activity of a process for obtaining a concrete UI part according to the first embodiment;

FIG. 15 is a diagram showing an example of the description of the UI parts designation information according to the first embodiment;

FIG. 16 is a diagram showing an example of a server/client system according to the second embodiment;

FIG. 17 is a class diagram showing an example of the server/client system according to the second embodiment; and

FIG. 18 is a block diagram showing an example of a hardware construction according to the first embodiment.

### DETAILED DESCRIPTION OF THE PREFERRED EMBODIMENTS

### First Embodiment

The first embodiment of the invention will be described in detail hereinbelow with reference to the drawings.

FIG. 18 is a block diagram showing an example of a hardware construction of an information processing apparatus according to the embodiment.

In the information processing apparatus shown in FIG. 18, an input unit 1 has a mouse, a keyboard, and the like and is used to input information (data). A CPU (controller) 2 executes an arithmetic operation, a logic discrimination, and the like for various processes in the information processing apparatus, thereby controlling component elements connected to a bus 6.

A displaying apparatus 3 is an LCD, a CRT, or the like.

A program memory 4 is a memory for storing a program for allowing the CPU 2 to execute processing procedures of flowcharts, which will be explained hereinafter. A ROM or a RAM in which the program is loaded from an external storing apparatus or the like may be used for the program memory 4.

A data memory 5 stores data obtained by the various processes. For example, a RAM may be used for the data memory 5. The information processing apparatus loads the data into the data memory 5 from a non-volatile external storing medium prior to executing the various processes or refers to the data from the data memory 5 in accordance with necessity. The data memory 5 holds information regarding the displaying apparatus such as size, resolution, and the like of a display screen of the displaying apparatus 3.

The bus 6 is used to transfer an address signal for instructing each component element as a target of the control of the CPU 2, a control signal for controlling each component element, and the data which is mutually transmitted and received among the component elements.

An external I/F (interface) 7 is a device for obtaining UI data from the outside such as a detachable external memory or the like.

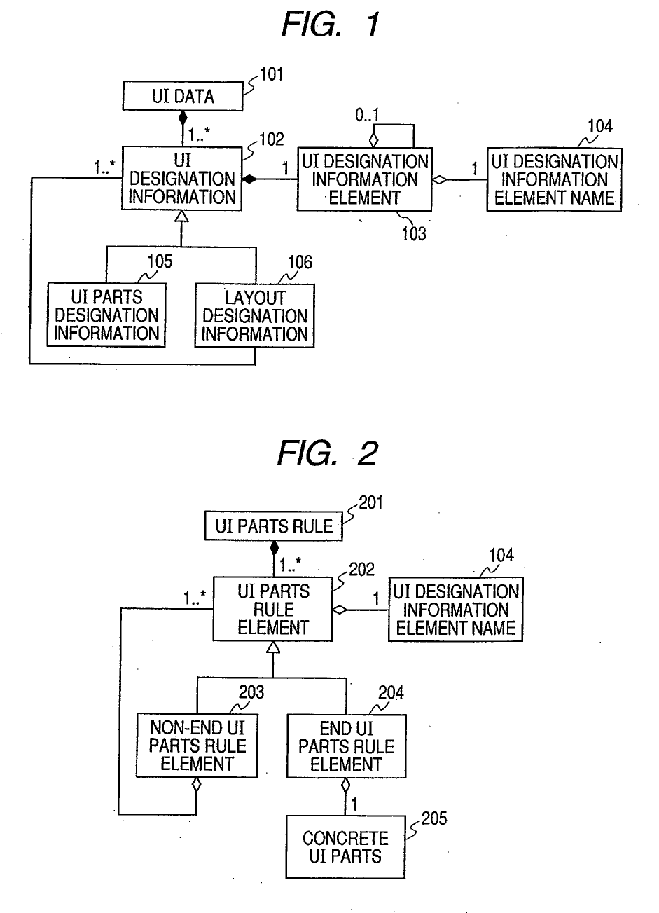

FIG. 1 is a class diagram showing an example of a structure of the UI data according to embodiment.

In FIG. 1, UI data 101 is data which is used for the information processing apparatus according to embodiment to construct the UI. The UI data 101 is constructed by one or more UI designation information 102 describing designation of the display of UI parts. The “UI data” is data for display-controlling the UI parts. In the embodiment, the “UI data” is described by an XForms language obtained by expanding an XML language. The “UI data” is data which is obtained by the information processing apparatus from the outside.

Conceptually, the UI designation information 102 is constructed by: UI parts designation information 105 for describing the designation of a type and the like of the UI parts; and layout designation information 106 for describing a layout of each UI part. The layout designation information includes UI designation alternative information. Each UI designation information 102 has one UI designation information element 103. There are a case where the UI designation information element 103 is constructed by a list structure and a case where it is not constructed by the list structure.

As will be explained hereinafter in FIG. 13, each UI designation information element 103 shows one stage of the layered abstraction degree and has one UI designation information element name 104 showing the abstraction degree. The layout designation information 106 includes one or more UI designation information 102, in its description, serving as a target of the layout.

FIG. 2 is a class diagram showing an example of a UI parts rule regarding the UI parts which have been layered step by step in accordance with a difference of the abstraction degrees. In the embodiment, it is assumed that the data of the UI parts rule has previously been stored in the program memory of the information processing apparatus.

In FIG. 2, a UI parts rule 201 regarding the UI parts is constructed by one or more UI parts rule elements 202.

Each UI parts rule element 202 is either a non-end UI parts rule element 203 or an end UI parts rule element 204. The non-end UI parts rule element 203 has one or more UI parts rule elements 202. The end UI parts rule element 204 is associated with one concrete UI part 205.

Thus, the UI parts rule 201 forms a tree structure. The UI parts rule elements 202 at the end is certainly the end UI parts rule element 204. Each UI parts rule element 202 is associated with one UI designation information element name 104. In the UI parts rule elements 202, each stage of the tree structure of the UI parts rule 201 expresses one stage of the layered abstraction degree.

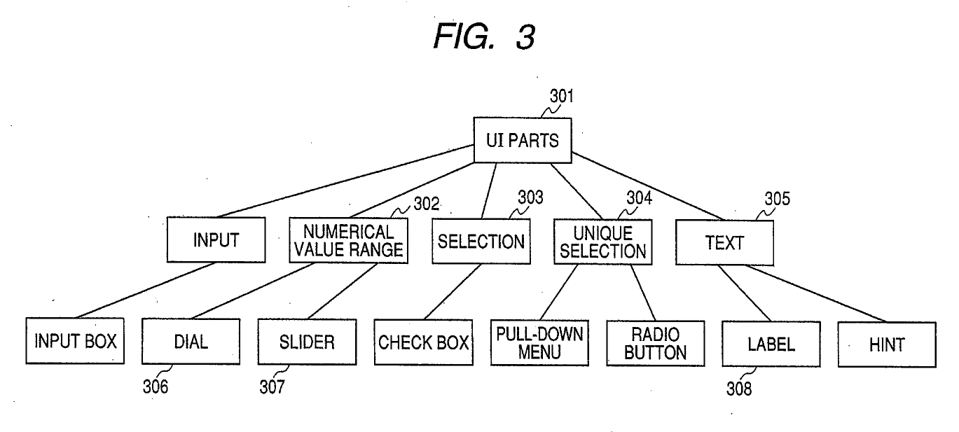

FIG. 3 is a diagram in the case where a plurality of types of UI parts in the UI parts rule regarding the UI parts in the information processing apparatus in the embodiment are shown by a tree structure as a specific example of FIG. 2. In the embodiment, data of a tool kit as UI parts has been stored as a library into the program memory 4 of the information processing apparatus. Although not shown in FIG. 3, the concrete UI parts of the tool kit have been associated with each classification at the end of the tree structure.

As shown in FIG. 3, first, UI parts 301 are classified into concepts of the abstracted parts such as numerical value range 302, selection 303, unique selection 304, text 305, and the like. They are the non-end UI parts rule elements 203. The UI parts 301 are further concreted and classified in the layer which is lower by one stage than those classification layers. For example, the UI parts 301 are collected to a dial 306 and a slider 307 as parts types to realize the numerical value range 302. They are the end UI parts rule elements 204.

In the embodiment, an attention is paid to a label 308 as one of the concrete parts of the text 305 and an explanation will be made with respect to the label associated with the control UI parts. An nput box will be described as an example of the control UI parts. In the embodiment, the term ontrol UI part is defined as UI part for selection or input operation by the user. In addition, the abel is text data associated with the control UI parts. The abel is one of the UI parts.

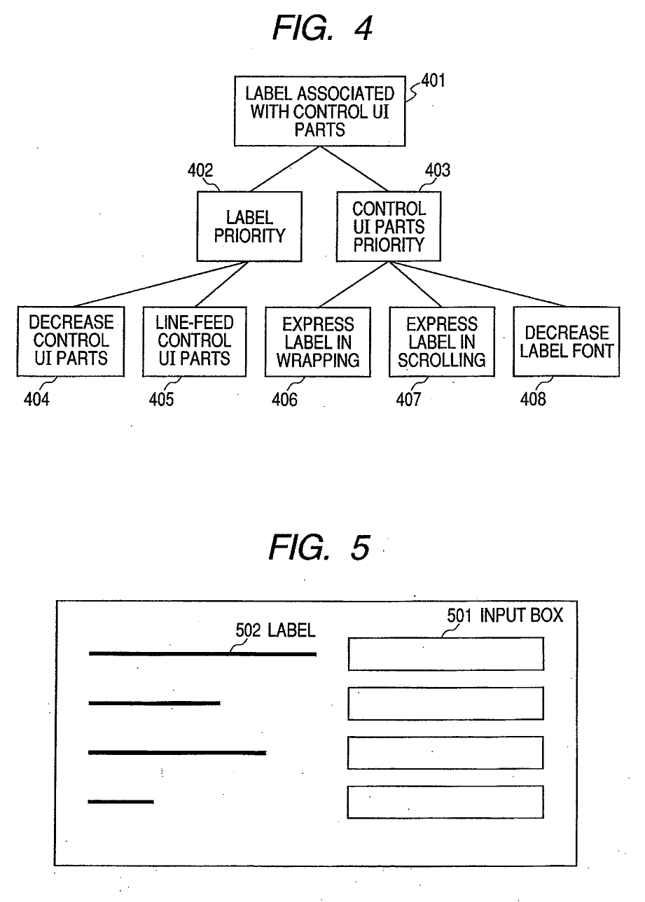

FIG. 4 is a diagram in the case where a display control rule of the label associated with the UI parts which can be operated by the user (hereinafter, referred to as control UI parts) such as an input box or the like is shown by a tree structure as an example of the UI parts. That is, a abel associated with the control UI parts 401 is arranged in the layer which is lower by one stage than that of the abel 308 in FIG. 3.

In the case of concreting the display control method of the abel associated with the control UI parts by one stage, the label 401 is classified into label priority 402 and control UI parts priority 403. In the case where it is necessary to change the layout of the UI because the display screen size is insufficient for the display of the UI parts, the riority shows which one of the label and the control UI parts which the user should not be changed. For example, in the case of the abel priority the display of the control UI parts is changed. In the case of the ontrol UI parts priority 403, the display of the label is changed.

As a case where the abel priority 402 is set, there is considered a case where the provider of the UI data does not like a change in expression of the label when it is fully displayed on the display screen of the displaying apparatus 3 as an output unit 3. On the contrary, as a case where the nput box priority is set, there is considered a case where the provider does not care even if the label is omitted or cut away or a case where he wants to reconstruct the display of the input box more accurately than that of the label.

In the embodiment, in the case of the abel priority 402, for example, ecrease control UI parts 404 and ine-feed control UI parts 405 can be set as concrete display control rules of the control UI parts. Similarly, in the case of the ontrol UI parts priority 403, xpress the label in wrapping 406, xpress label in scrolling 407, and ecrease the label font 408 can be set as concrete display control rules of the label.

For example, when the display screen of the displaying apparatus 3 is relatively large, as shown in FIG. 5, a combination of an input box 501 and a label 502 as control UI parts can be displayed in a desired manner.

A description of the UI data corresponding to the UI parts shown in FIG. 5 described as an XForms language expanded by using the HTML as a host language is as follows. In the following description, I designation alternative information and xy coordinates information of esignation of the label and esignation of the control UI parts correspond to the ayout designation information 06. Descriptions of abel_box in the following I designation information and abel and ox in the following esignation of the font and esignation of the label correspond to the I parts designation information 05. The UI designation alternative information will be described hereinafter.

<!-- UI designation information -->
<type = text/label_box >
<!-- UI designation alternative information -->
<sub_type = text/label_box/label_priority/
control_resize >
<!-- designation of font -->
<text font-family = XXX font-size = 14/>
<!-- designation of label -->
<label x = 10y = 10> Label1 </label>
<!-- designation of control UI parts -->
<box x = 100y = 10/>

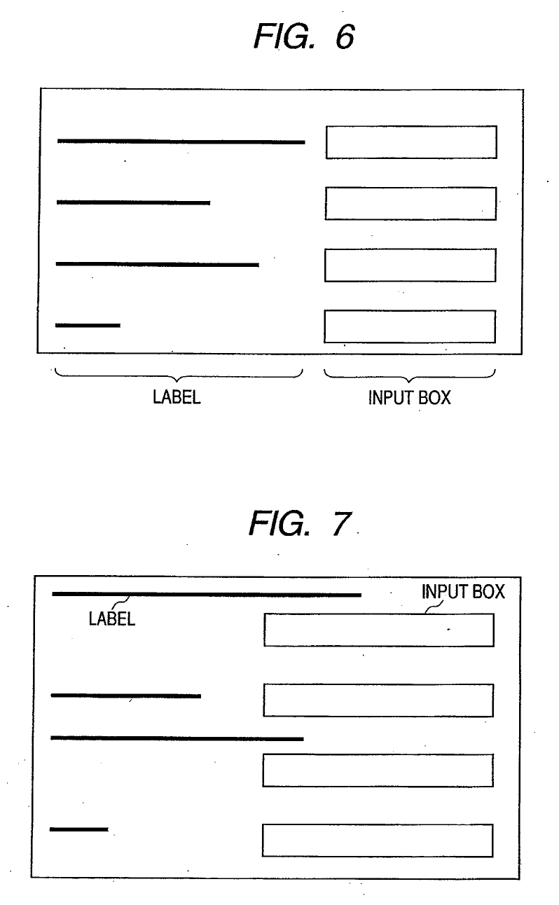

The UI designation alternative information is referred to when the UI parts shown in FIG. 5 are displayed on the small display screen. For example, when the provider of the UI data wants to give priority to the display of the label, the foregoing UI designation alternative information is described. By such a description, the display of the label is maintained as shown in FIG. 6 and the display control process for decreasing the input box is performed.

When the provider of the UI data wants to designate the method of line-feeding the input box and executing the display control process as shown in FIG. 7, the UI designation alternative information is described as follows.

<sub_type = text/label_box/label_priority/
control_break

In the case where there is such an intention of the provider of the UI data that he does not want the situation that the label is omitted, or the like, the intention of the provider of the UI data can be also reflected by setting the display control processing method as mentioned above.

In the abel priority 402, even if there is a description in the UI parts designation information 105 so as to decrease the input box, there is also a case where the input box cannot be displayed small in dependence on the display screen. For example, as such a case, there can be mentioned a case where the input box is set to the minimum size in which text data is inputted into the input box and the inputted text data can be recognized on the display screen.

In such a case, the information processing apparatus determines that the display control processing method of decreasing the input box is improper, and sets the second best alternative display control method.

When the provider of the UI data wants to give priority to the display of the control UI parts, the UI designation alternative information is described as follows and the display control process of the label is selectively executed.

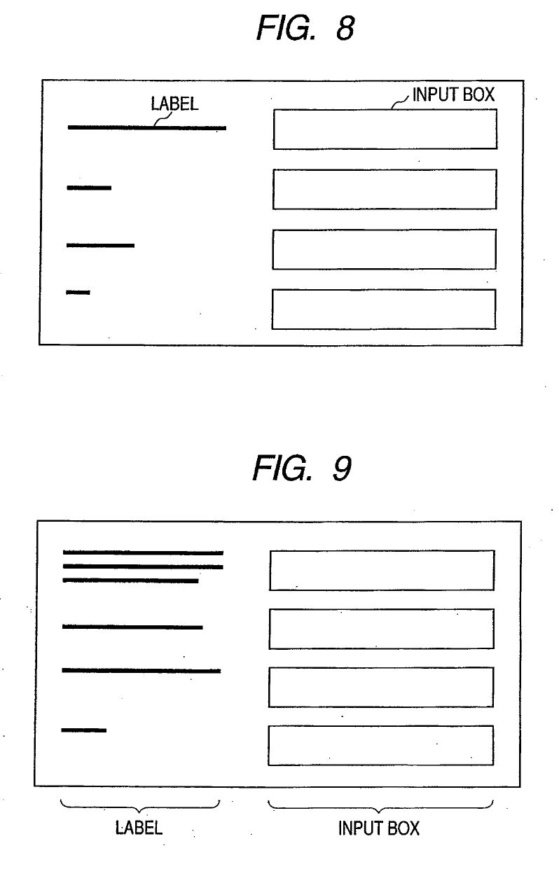

FIG. 9: The label is folded back at a predetermined width in the wrapping (406).

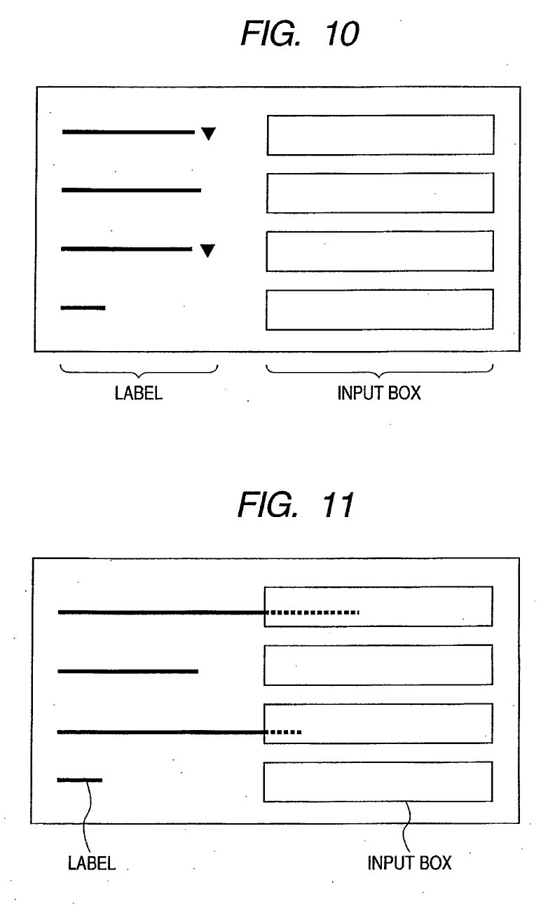

```
<sub_type = text/label_box/control_priority/
    label_wrap
. The label is expressed in scrolling as shown in Fig. 10 (407).
<sub_type = text/label_box/control_priority/
    label_scroll
. The font size of the label is decreased as shown in Fig. 8 (408).
<sub_type = text/label_box/control_priority/
    label_resize
```

For example, even if the font size of the text data of the label decreases, if the provider of the UI data wants to preferentially adapt it to the information processing apparatus having the display screen of high precision which can be easily seen, the designation alternative information corresponding to the display control processing method shown in FIG. 8 is described in the UI data.

In the case of the elongated display screen or the display screen which can display data by a fine space between lines, the designation alternative information corresponding to the display control processing method (wrapping) shown in FIG. 9 is used.

In the case of the ontrol UI parts priority 403, the second best alternative display control similar to the case of the abel priority 402 can be also executed. For example, even if there is a description in the UI parts designation information 105 so as to decrease the font size, there is a case where the decrease in the font size is restricted because the resolution of the display screen of the displaying apparatus 3 is low. In such a case, as an alternative display control process, the information processing apparatus executes a process for displaying the label in scrolling or the like with reference to the UI parts rule shown in FIG. 4.

A method of displaying the label so as to be overlapped on the input box as shown in FIG. 11 is also considered, or a method whereby the label is omitted to an arbitrary number of characters can be set, or further, if there is an animation function, a method whereby a character train of the label is moved little by little and displayed, or the like can be also set. When the label is displayed on the display screen without the overlap displaying function or the animation function, the further second best displaying method of the designated alternative method is selected.

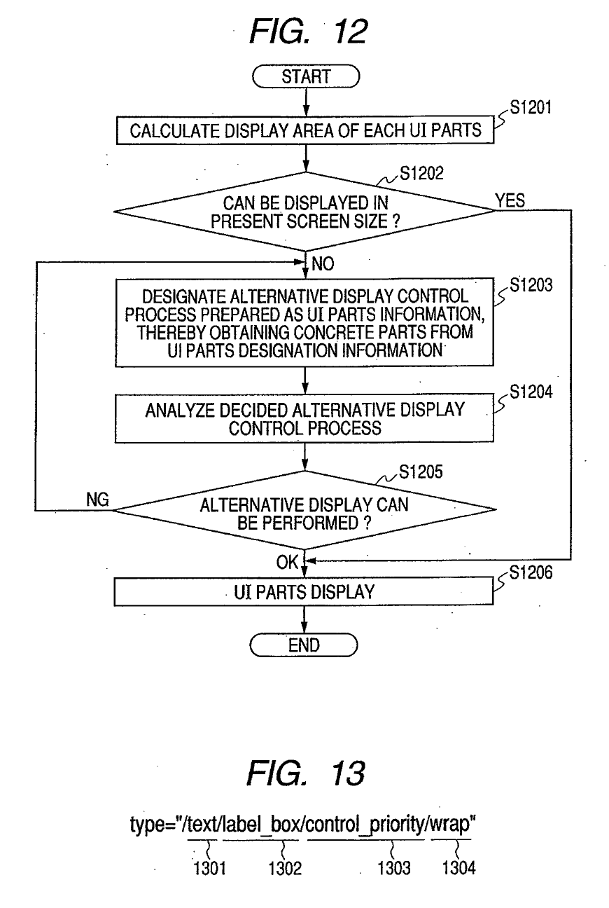

FIG. 12 is a processing flowchart for the operation of the information processing apparatus showing the alternative display control in the case where the UI parts cannot be displayed in the display screen of the displaying apparatus 3.

First, the CPU 2 analyzes the target U data in step S1201. Specifically speaking, the CPU 2 selects the UI parts corresponding to the UI parts designation information from the library. The CPU 2 calculates an area necessary to display each UI part on the basis of the layout designation information (a font size and display position information of the text data and a size and display position information of the control UI parts) of the selected UI parts.

Subsequently, in step S1202, the CPU 2 refers to the information regarding the displaying apparatus 3 from the data memory 5 and discriminates whether or not the selected UI parts are displayed.

Specifically speaking, the CPU 2 refers to the screen size of the displaying apparatus 3 which has previously been stored in the data memory 5 and discriminates whether or not the calculated area lies within the display screen of the displaying apparatus. The CPU 2 also refers to the resolution of the displaying apparatus 3 which has previously been stored in the data memory 5. The CPU 2 discriminates whether or not the font size of the text data described in the layout designation information is equal to or smaller than a predetermined size in which the recognition is difficult at the referred resolution.

If it is determined in step S1202 that each UI part lies within the display screen of the display size, the processing routine advances to step S1206. The CPU 2 allows the UI parts to be displayed on the display screen of the displaying apparatus 3 and finishes the process. If it is determined in step S1202 that a part of the UI parts cannot be fully displayed on the display screen of the displaying apparatus 3, the processing routine advances to step S1203. The CPU 2 extracts the concrete UI parts from the library on the basis of the UI parts designation information and designates the alternative display control process.

If the description of the UI designation alternative information does not exist in the UI data, the display control process which can be executed by the information processing apparatus is executed.

In step S1204, the CPU 2 analyzes the UI parts and their display control process designated in step S1203.

Subsequently, in step S1205, the CPU 2 discriminates whether or not the analyzed UI parts and display control process are suitable for the screen display of the displaying apparatus 3. In step S1205, the CPU 2 discriminates whether or not the font size of the text data is not smaller than the minimum font size which has been preset in the display screen, whether or not each UI part lies within the display screen of the displaying apparatus 3 by the designated alternative display control process, or the like. This discrimination is similar to that in step S1202.

If a result of the discrimination by the CPU 2 in step S1205 indicates OK, step S1206 follows and the CPU 2 completes the display control process of the UI parts. If the discrimination result in step S1205 indicates NG, the processing routine is returned to step S1203. The CPU 2 refers to the display control processing rule shown in FIG. 4 and sets the second best display control process again.

First, the CPU 2 tries a display control process corresponding to the description of the UI designation alternative information. If the discrimination result indicates NG even in this case, then the CPU 2 tries a display control process for a display control rule derived from the element placed in the upper layer from among the control rules shown in FIG. 4. If the discrimination result again indicates NG in the display control process for the derived display control rule, the CPU 2 selects another display control rule derived from the upper layer element, and tries the display control process for that rule.

For example, if the display control rule 408 is described as the UI designation alternative information, the CPU 2 first tries a display control process corresponding to the description of the rule 408. If the display control process is discriminated as NG, then the CPU 2 tries a display control process for either one of the display control rules 406 and 407 derived from the element 403 placed in the upper layer. If the display control process for the rule 406 or 407 is discriminated as NG, the CPU 2 executes a display control process for either one of the display control rules 404 and 405 derived from the element 401 placed in the further upper layer.

If no second best display control process(es) is set, the CPU 2 executes the display control process currently set in step S1206.

The CPU 2 repeats the processes of steps S1203 to S1205 until the discrimination result in step S1205 indicates OK, that is, until it is determined that the alternative display control process for the UI parts corresponding to the UI parts designation information can be executed.

If it is determined in step S1205 that all of the display control processes do not correspond to the display screen of the displaying apparatus 3, the display control process regarding the second best UI part is executed. In FIG. 3, the alternative display control process using int as a second best UI part of the label is executed.

FIG. 13 shows an example of the UI parts designation information of the label having the description regarding the alternative display control process in the description of the UI data described as an XForms language expanded by using the HTML as a host language, on the basis of the description of the XML.

In the description of the UI parts designation information in FIG. 13, an element 1301 shows that the UI part of the text is designated. An element 1302 shows that the text is the label. Further, an element 1303 shows that the display of the control UI parts corresponding to the label has priority to that of the label. An element 1304 shows that the alternative displaying method in the case where the UI parts cannot be fully display on the display screen of the displaying apparatus 3 is the wrap expression of the label mentioned above.

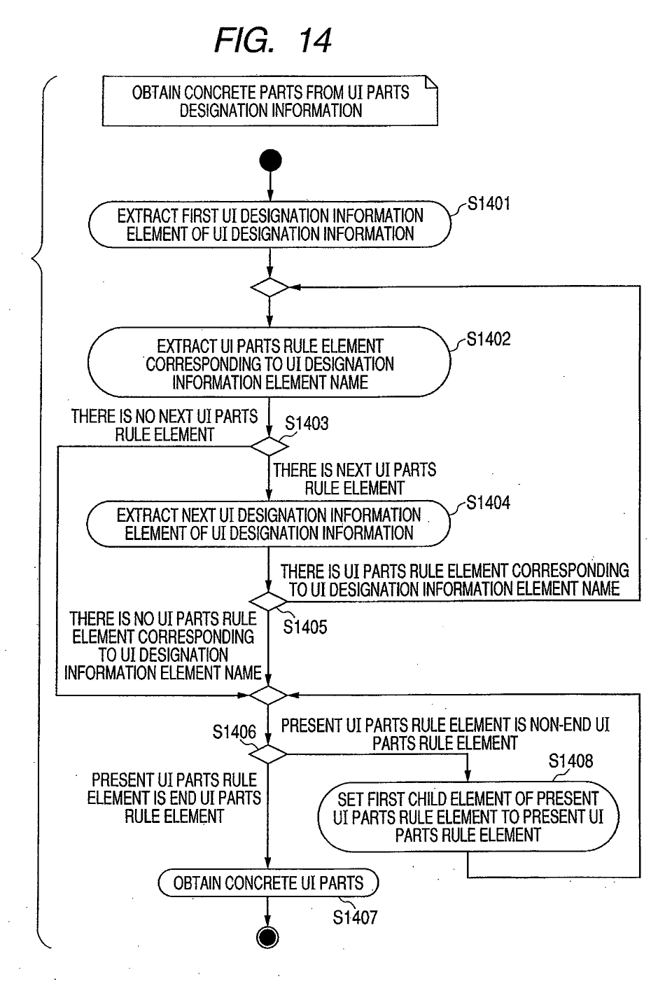

FIG. 14 is an activity diagram showing an example of the process of the information processing apparatus for obtaining the concrete UI parts having the designation of the expressing method from the UI parts designation information and such a process is executed in step S1203 in FIG. 12.

In FIG. 14, first, the CPU 2 extracts the first UI designation information element of the UI designation information (step S1401). The CPU 2 sets the UI parts rule corresponding to the UI designation information element to the present UI parts rule element (step S1402).

Subsequently, the CPU 2 discriminates whether or not the next UI designation information element exists in the UI designation information (step S1403). If the next UI designation information element exists, the CPU 2 obtains the next UI designation information element from the UI designation information (step S1404) and discriminates the presence or absence of the UI parts rule element corresponding to the UI designation information element (step S1405). If the CPU 2 determines in step S1403 that the next UI designation information element does not exist in the UI designation information, step S1406 follows.

As a result of the discrimination of step S1405, if the CPU 2 determines that the UI parts rule element corresponding to the UI designation information element exists, the processing routine is returned to the process of step S1402. If the corresponding UI parts rule element does not exist, step S1406 follows.

In step S1406, the CPU 2 discriminates whether ornot the present UI parts rule element is the end UI parts rule element. If it is the end UI parts rule element, the CPU 2 obtains the concrete UI parts associated with such an element from the library (step S1407) and finishes the process.

As a result of the discrimination of step S1406, if the present UI parts rule element is not the end UI parts rule element, the CPU 2 sets the first child element which the present UI parts rule element has to the present UI parts rule element (step S1408) and returns to the discriminating step S1406.

The process in FIG. 14 will be specifically explained with respect to the UI parts designation information shown in FIG. 13 as an example. In step S1401 in FIG. 14, ext 1301 as a first UI designation information element is extracted from the UI parts designation information in FIG. 13. In step S1402, the existence of the UI parts rule ext 305 in FIG. 3 corresponding to the text is recognized.

In step S1404, the description of abel 1302 as a UI designation information element is extracted from the UI parts designation information whose existence has been confirmed in step S1403. In step S1405 (step S1402), the existence of the label 308 of the UI parts rule in FIG. 3 is recognized. Further, it is recognized in step S1403 that there is a continuation in the description of the UI parts designation information. In step S1404, ontrol_priority 1303 as a UI designation information element is extracted.

It is recognized in step S1405 (step S1402) that the control priority (ontrol_priority 403 exists in the UI parts rule.

Further, in step S1404, “wrap” 1304 is obtained from the UI parts designation information in FIG. 13. Similarly, in step S1405 (step S1402), it is recognized that the xpress label in wrapping 406 exists in the UI parts rule.

Since it is determined in step S1403 that there is no continuation of the UI parts designation information, step S1406 follows. Since the rap 406 is a UI parts rule element at the end, the label of rapping as a concrete UI part is obtained in step S1407.

In this manner, the concrete part of the tool kit having the setting such as rapping is selected from the library by the UI parts designation information in which up to the end UI parts rule element having the concrete UI part in FIG. 13 have been designated.

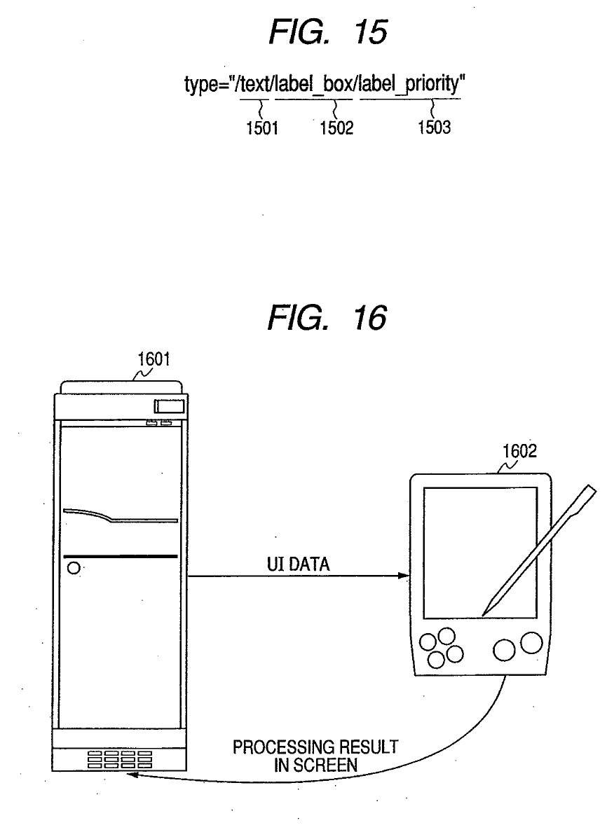

FIG. 15 shows another example describing the UI parts designation information of the label having the alternative displaying method in the UI data described as an XForms language expanded by using the HTML as a host language, on the basis of the description of the XML. In FIG. 15, an element 1501 shows that the UI part of the text has been designated. An element 1502 describes that the UI part is the label. Further, an element 1503 shows that the label display has priority to that of the of the control UI parts corresponding to the label. However, in the description of FIG. 15, the element 1503 is not the end UI parts rule element.

The process of the CPU 2 shown in FIG. 14 when the parts are selected on the basis of the parts designation information in FIG. 15 as mentioned above will now be described.

In step S1401 in FIG. 14, the CPU 2 extracts the ext 1501 as a first UI designation information element from the UI parts designation information in FIG. 15. In step S1402, the CPU 2 recognizes the existence of the UI parts rule (ext 305 in FIG. 3) corresponding to the ext 1501.

In step S1403, the CPU 2 confirms that there is a continuation in the description of the UI parts designation information, advances to step S1404, and extracts the element abel 1502 of the UI parts designation information. In step S1405 (step S1402), the CPU 2 recognizes the existence of the UI parts rule corresponding to the element abel 1502.

The CPU 2 recognizes in step S1403 that there is a continuation in the description of the UI parts designation information and extracts the element abel_priority 1503 in step S1404. The CPU 2 recognizes the existence of the UI parts rule 402 corresponding to the element abel_priority 1503.

The CPU 2 recognizes in step S1403 that there is no continuation in the description of the UI parts designation information and advances to the process of step S1406. Since the abel_priority 402 is not the UI parts rule at the end in step S1406, the processing routine advances to step S1408.

In step S1408, an arbitrary child element is selected from the child elements of the abel_priority 402. For example, a display setting ecrease the control UI parts as a child element 404 among the child elements is obtained. Returning to step S1406, since the element 404 is an end UI parts rule element, the input box with the label of the display in which the input box as a concrete UI part has been decreased is obtained in step S1407. After that, in the process of step S1205 in FIG. 12, a case where the size of input box is smaller than the font size of the text which is inputted is presumed. If the screen display of the displaying apparatus 3 is improper as mentioned above, as alternative display control, the CPU 2 selects ine-feed the control UI parts as another child element 405 of the abel_priority 402.

As mentioned above, even in the UI parts designation information which does not designate up to the end UI parts rule element having the concrete UI part in FIG. 15, such a display intended by the provider of the UI parts that the control UP part is displayed small can be performed.

As described above, according to the embodiment, when the display control of the UI parts is executed on the basis of the UI parts rule, the alternative display control process in the case where the display screen is insufficient for the UI display can be set. Further, even if the UI rule is not finely set, the UI display is determined by the suitable alternative display control process.

### Second Embodiment

The embodiment will be described with respect to a server/client system constructed by a server which provides functions of applications and a client which is connected to the server through a network and uses the functions.

FIG. 16 is a diagram showing an example of the server/client system in the embodiment.

In FIG. 16, a server 1601 is an information processing apparatus which provides the functions of the applications. A client terminal 1602 is an information processing apparatus which uses those functions. The server 1601 and the client terminal 1602 are connected through the network.

The client terminal 1602 receives UI data 1603 formed in the server 1601. By the display control process shown in the first embodiment, the client terminal 1602 displays the UI parts for using the functions. A processing result 1604 in the display screen which has been obtained by the operation of the user and detected through the UI parts is transmitted to the server 1601 and the function corresponding to an instruction is executed.

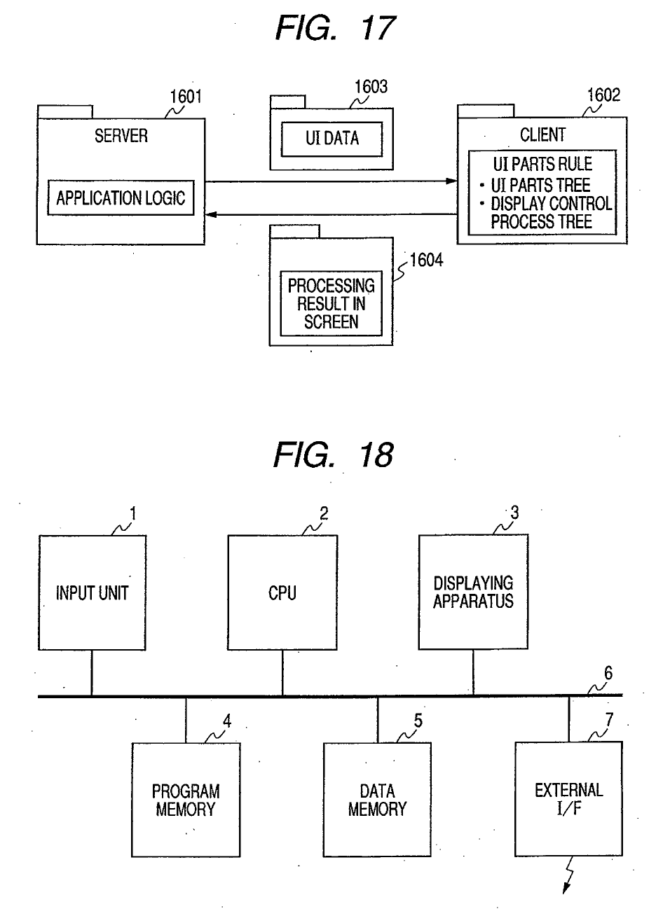

FIG. 17 shows an example of a class diagram of the server/client system in the embodiment.

In FIG. 17, the server 1601 has an application logic for providing the functions of the applications. To use the functions, the client terminal 1602 has a UI parts rule necessary for interpreting the UI data 1603 received from the server 1601 and executing the display control process of the UI parts. The selection of types of UI parts and the display control process of the UI parts are executed by the UI parts rule. The processing result 1604 in the display screen which has been obtained by the operation of the user and detected through the UI parts is transmitted to the server 1601. The server 1601 executes the process corresponding to the processing result 1604 in the display screen.

The client terminal 1602 which received the UI data 1603 uses a result of the interpretation as a UI part and executes the display control process by using the UI parts rule. The client terminal 1602 notifies the server 1601 of a result of the user operation executed through the UI part by the operator by issuing, for example, an event. The server which received the result of the user operation uses its value for the application control. If necessary, the server transmits the result to the client terminal 1602 again.

As described above, according to the embodiment, merely by distributing the same UI data to every type of client terminal, the server can provide the functions of the applications. Even if the UI corresponding to the UI data does not exist in the client terminal, it can be constructed by the second best UI.

### Other Embodiments According to the Invention

Each of the means constructing the information processing apparatus in the foregoing embodiments of the invention and each of the processing steps of the information processing method can be realized by a method whereby a program stored in a RAM, a ROM, or the like of a computer operates. The program and a computer-readable recording medium in which the program has been recorded are incorporated in the invention.

The invention can be also embodied as, for example, a system, an apparatus, a method, a program, a recording medium, or the like. Specifically speaking, the invention can be applied to a system constructed by a plurality of apparatuses or can be also applied to an apparatus constructed by one equipment.

The invention also incorporates a case where a program of the software for realizing the functions of the foregoing embodiments (in the embodiments, program corresponding to the flowcharts shown in FIGS. 12 and 14) are supplied to a system or an apparatus directly or from a remote place, and a computer in the system or apparatus reads out and executes program codes of the supplied program, so that the functions are accomplished.

Therefore, the program codes themselves which are installed into the computer in order to realize the functional processes of the invention by the computer also realize the invention. That is, the computer program itself to realize the functional processes of the invention is also incorporated in the invention.

In such a case, a format of the program is not particularly limited but the program may have any format of an object code, a program which is executed by an interpreter, script data which is supplied to an OS, or the like so long as it has the functions of the program.

As a recording medium for supplying the program, for example, there is a floppy (registered trademark) disk, a hard disk, an optical disk, a magnetooptic disk, an MO, a CD-ROM, a CD-R, a CD-RW, a magnetic tape, a non-volatile memory card, a ROM, a DVD (DVD-ROM, DVD-R), or the like.

As another program supplying method, the program can be also supplied by a method whereby a client computer is connected to Homepage of the Internet by using a browser of the client computer and the computer program itself of the invention is downloaded from Homepage or a method whereby a compressed file including an automatic installing function is downloaded into the recording medium such as a hard disk or the like, thereby supplying the program.

The program supplying method can be also realized by a method whereby the program code constructing the program of the invention is divided into a plurality of files and each file is downloaded from different Homepage. That is, a WWW server for downloading a program file to realize the functional processes of the invention by the computer to a plurality of users is also incorporated in the invention.

The program supplying method can be also realized by a method whereby the program of the invention is encrypted, stored into a recording medium such as a CD-ROM or the like, and distributed to the users, the users who has cleared predetermined conditions are allowed to download key information for encrypting the encryption from Homepage through the Internet, and the encrypted program is executed by using the key information and installed into the computer.

The functions of the embodiments mentioned above can be realized by a method whereby the computer executes the read-out program or a method whereby an OS or the like which is operating on the computer executes a part or all of actual processes on the basis of instructions of the program and the functions are realized by those processes.

Further, the functions of the embodiments mentioned above are realized by a method whereby the program read out of the recording medium is written into a memory provided for a function expanding board inserted in the computer or a function expanding unit connected to the computer, thereafter, a CPU or the like provided for the function expanding board or the function expanding unit executes a part or all of actual processes on the basis of instructions of the program, and the functions are realized by those processes.

This application claims priority from Japanese Patent Application No. 2005-157968 filed on May 30, 2005, which is hereby incorporated by reference herein.

What is claimed is:

1. An information processing apparatus for controlling a display of user interface parts, comprising:
an obtaining device adapted to obtain user interface data for displaying the user interface parts onto a display screen of a displaying apparatus from an external apparatus; and
a controller adapted to discriminate whether or not the user interface part corresponding to user interface parts designation information of the user interface data obtained through an interface is displayed on the display screen of the displaying apparatus by a display control process corresponding to layout designation information of the user interface data on the basis of information regarding the display screen of the displaying apparatus,
wherein if it is determined that the user interface part is not displayed on the display screen of the displaying apparatus, said controller allows the user interface part corresponding to the user interface parts designation information to be displayed by an alternative display control process of the user interface part by referring to alternative user interface parts designation information of the user interface data obtained through the interface.

2. An apparatus according to claim 1, wherein if it is determined that the alternative display control process of the user interface part is not suitable for the display on the display screen of the displaying apparatus either on the basis of the information regarding the display screen of the displaying apparatus, said controller executes a second best display control process of the user interface part with reference to information regarding a layered display control rule of the user interface part.

3. An apparatus according to claim 1, wherein the information regarding the display screen of the displaying apparatus is at least one of a size and a resolution of the display screen.

4. A display control processing method for an information processing apparatus for controlling a display of user interface parts, comprising:
an obtaining step of obtaining user interface data for displaying the user interface parts onto a display screen of a displaying apparatus from an external apparatus;
a discriminating step of discriminating whether or not the user interface part corresponding to user interface parts designation information of the user interface data obtained through an interface is displayed on the display screen of the displaying apparatus by a display control process corresponding to layout designation information of the user interface data on the basis of information regarding the display screen of the displaying apparatus; and
a display control processing step of, if it is determined that the user interface part is not displayed on the display screen of the displaying apparatus, displaying the user interface part corresponding to the user interface parts designation information by an alternative display control process of the user interface part by referring to alternative user interface parts designation information of the user interface data obtained through the interface.

5. A method according to claim 4, wherein if it is determined that the alternative display control process of the user interface part is not suitable for the display on the display screen of the displaying apparatus either on the basis of the information regarding the display screen of the displaying apparatus, a second best display control process of the user interface part is executed with reference to information regarding a layered display control rule of the user interface part.

6. A method according to claim 4, wherein the information regarding the display screen of the displaying apparatus is at least one of a size and a resolution of the display screen.

7. A computer program, stored in a computer-readable storage medium, for allowing a computer to execute a display control processing method for an information processing apparatus for controlling a display of user interface parts, wherein the display control processing method comprises:
an obtaining step of obtaining user interface data for displaying the user interface parts onto a display screen of a displaying apparatus from an external apparatus;
a discriminating step of discriminating whether or not the user interface part corresponding to user interface parts designation information of the user interface data obtained through an interface is displayed on the display screen of the displaying apparatus by a display control process corresponding to layout designation information of the user interface data on the basis of information regarding the display screen of the displaying apparatus; and
a display control processing step of, if it is determined that the user interface part is not displayed on the display screen of the displaying apparatus, displaying the user interface part corresponding to the user interface parts designation information by an alternative display control process of the user interface part by referring to alternative user interface parts designation information of the user interface data obtained through the interface.

8. A program according to claim 7, wherein if it is determined that the alternative display control process of the user interface part is not suitable for the display on the display screen of the displaying apparatus either on the basis of the information regarding the display screen of the displaying apparatus, a second best display control process of the user interface part is executed with reference to information regarding a layered display control rule of the user interface part.

9. A program according to claim 7, wherein the information regarding the display screen of the displaying apparatus is at least one of a size and a resolution of the display screen.
